(19) United States
(12) Patent Application Publication
(10) Pub. No.: US 2017/0186148 A1
(43) Pub. Date: Jun. 29, 2017

(54) INSPECTION APPARATUS, INSPECTION SYSTEM, AND METHOD OF MANUFACTURING ARTICLE

(71) Applicant: CANON KABUSHIKI KAISHA, Tokyo (JP)

(72) Inventor: Takanori Uemura, Saitama-shi (JP)

(21) Appl. No.: 15/387,687

(22) Filed: Dec. 22, 2016

(30) Foreign Application Priority Data
Dec. 28, 2015 (JP) 2015-257327

(51) Int. Cl. G06T 7/00; H04N 5/225; H04N 7/18

(52) U.S. Cl. CPC G06T 7/0004; H04N 7/181; H04N 5/2256

(57) ABSTRACT

The present invention provides an inspection apparatus that performs an inspection of an appearance of a surface, the apparatus comprising a plurality of imaging devices, an illumination device including a plurality of light sources, and a processor, wherein the plurality of imaging devices are arranged such that azimuth directions, in which the plurality of imaging devices respectively images the surface, are mutually different, and wherein the processor is configured to control, in a case where each of the plurality of imaging devices is caused to image the surface, the illumination device such that the surface is illuminated by a light source, of the plurality of light sources, of which an angle difference between an azimuth angle in which the surface is imaged and an azimuth angle in which the surface is illuminated is less than 90 degrees.

### BACKGROUND OF THE INVENTION

Field of the Invention

The present invention relates to an inspection apparatus for inspecting an appearance of a surface, an inspection system, and a method of manufacturing an article.

Description of the Related Art

In surface appearance inspections, an inspection apparatus that inspect the appearance of the surface based on an image of the surface in place of an inspection by visual observation continues to be introduced. In Japanese Patent Laid-Open No. 2014-215217, an inspection apparatus is proposed in which, by a single camera arranged on above the surface, imaging of the surface is performed a plurality of times while changing a direction (azimuth angle) in which the surface is illuminated, and a defect (a scratch or the like) of a surface is inspected based on a combined image obtained by combining a plurality of images thereby obtained.

In recent years, there is a demand for inspecting a surface so that tiny scratches having a width or a depth of a scale approximately equal to that of a surface roughness of the surface, or less than that are detected in an inspection apparatus. In order to inspect a surface in this way, it is desirable to configure an inspection apparatus so that a ratio or a difference of an intensity of a light that is reflected by a defect of the surface and is incident on the camera in relation to an intensity of the light that is reflected by parts other than the defect in the surface and is incident on the camera becomes larger.

### SUMMARY OF THE INVENTION

The present invention provides, for example, an inspection apparatus advantageous in magnitude of a signal relative to magnitude of a noise.

According to one aspect of the present invention, there is provided an inspection apparatus that performs an inspection of an appearance of a surface, the apparatus comprising: a plurality of imaging devices each of which is configured to image the surface obliquely from above the surface; an illumination device including a plurality of light sources and configured to illuminate the surface from mutually different directions; and a processor configured to cause each of the plurality of imaging devices to image the surface, and perform processing of the inspection based on a plurality of images obtained by the plurality of imaging devices, wherein the plurality of imaging devices are arranged such that azimuth directions, in which the plurality of imaging devices respectively images the surface, are mutually different, and wherein the processor is configured to control, in a case where each of the plurality of imaging devices is caused to image the surface, the illumination device such that the surface is illuminated by a light source, of the plurality of light sources, of which an angle difference between an azimuth angle in which the surface is imaged and an azimuth angle in which the surface is illuminated is less than 90 degrees.

According to one aspect of the present invention, there is provided an inspection apparatus that performs an inspection of an appearance of a surface, the apparatus comprising an illumination device configured to illuminate the surface obliquely from above the surface; an imaging device configured to image the surface obliquely from above the surface; a processor configured to perform processing of the inspection based on an image obtained by causing the imaging device to image the surface illuminated by the illumination device, wherein the apparatus is configured such that the illumination device illuminates the surface in an azimuth direction in which the imaging device images the surface.

According to one aspect of the present invention, there is provided a method for manufacturing an article, the method comprising steps of: performing an inspection of an appearance of a surface of an object using an inspection apparatus; and processing the object, of which the inspection is performed, to manufacture the article, wherein the inspection apparatus includes: an illumination device configured to illuminate the surface obliquely from above the surface; an imaging device configured to image the surface obliquely from above the surface; a processor configured to perform processing of the inspection based on an image obtained by causing the imaging device to image the surface illuminated by the illumination device, wherein the apparatus is configured such that the illumination device illuminates the surface in an azimuth direction in which the imaging device images the surface.

Further features of the present invention will become apparent from the following description of exemplary embodiments with reference to the attached drawings.

### BRIEF DESCRIPTION OF THE DRAWINGS

FIG. 1 is a schematic view illustrating a visual inspection system.

FIG. 2A is a view illustrating a configuration of an illumination device.

FIG. 2B is a view illustrating a configuration of the illumination device.

FIG. 3 is a flowchart illustrating a method of inspecting a surface appearance.

FIG. 4 is a flowchart illustrating a method of imaging a surface by a main imaging device.

FIG. 5 is perspective views of the illumination device as seen from above.

FIG. 6 is views illustrating images of defects of a surface obtained by the main imaging device.

FIG. 7 is views illustrating combined images used in an appearance inspection.

FIG. 8A is a perspective view of the illumination device as seen from above.

FIG. 8B is a perspective view of the illumination device as seen from above.

FIG. 9 is a view illustrating an intensity distribution of scattered light in a normal portion of the surface.

FIG. 10 is a view illustrating a relationship between an imaging angle θc of a sub imaging device and an S/N ratio.

FIG. 11 is views illustrating images obtained by a sub imaging device.

FIG. 12A is a view for explaining an arrangement of a sub imaging device.

FIG. 12B is a view for explaining an arrangement of a sub imaging device.

### DESCRIPTION OF THE EMBODIMENTS

Exemplary embodiments of the present invention will be described below with reference to the accompanying drawings. Note that the same reference numerals denote the same members throughout the drawings, and a repetitive description thereof will not be given.

[Device Configuration]

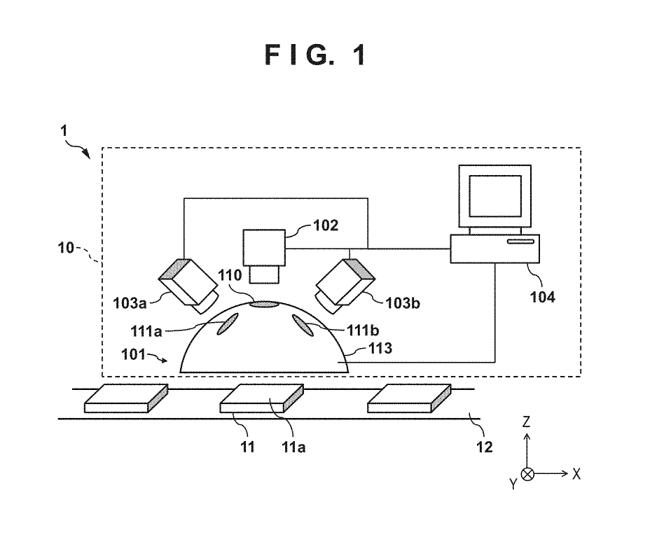

A visual inspection system 1 according to the present invention is explained. FIG. 1 is a schematic view illustrating a visual inspection system 1. The visual inspection system 1 may include an inspection apparatus 10 for performing an appearance inspection of a work 11 (a target object) having a surface 11a (a surface to be inspected) which is a plane, and a conveyance apparatus 12 (for example, a conveyor) for conveying the work 11 to a position where the inspection apparatus 10 performs the appearance inspection for example. The work 11 is a metal part or a resin part used for an industrial product for example. There are cases where a defect such as a scratch, an unevenness, a bump or the like is formed on the surface of the work 11, and the inspection apparatus 10 detects these defects, and the work 11 is classified as either a non-defective product or a defective product based on the detection result. Also, while a conveyor is used for the conveyance apparatus 12 in the present embodiment, the work 11 may be conveyed by another means such as a robot, a slider or manual placement.

The inspection apparatus 10 may include an illumination device 101, a main imaging device 102 (a second imaging device), a plurality of sub imaging devices 103 (103a and 103b) (imaging devices) and a control unit 104. The main imaging device 102 and a plurality of sub imaging devices 103 are area sensor cameras which include image sensors, such as a CCD image sensor or a CMOS image sensor for example, on which pixels are arranged two-dimensionally and which image the surface 11a of the work 11. By using the area sensor cameras in this way, it is possible to collectively obtain images of a field that is wider compared to a line sensor camera, so it is possible to perform an appearance inspection of the work 11 at high speed. Also, the control unit 104 is configured by a computer having for example a CPU and a memory, and it controls each part of the inspection apparatus 10. The control unit 104 of the present embodiment has a function as a processor for performing processing according to an appearance inspection of the work 11 (surface 11a) based on a plurality of images obtained by the main imaging device 102 and the plurality of sub imaging devices 103. However, it is not limited to this, and the processor may be provided separately from the control unit 104.

The main imaging device 102 may be arranged so as to image the surface 11a from above, that is, an angle (hereinafter referred to as an imaging angle θc) formed by a direction in which the surface 11a is imaged and the surface 11a is 90 degrees. Also, each of the plurality of the sub imaging devices 103 may be arranged so as to image the surface 11a obliquely from above, that is, so that the imaging angle θc is less than 90 degrees. It is advantageous that each of the plurality of sub imaging devices 103 is arranged so that the imaging angle θc is in a range of 60±10 degrees. Also, the plurality of sub imaging devices 103 are arranged so that the azimuth angles φ at which they image the surface 11a differ to each other. The plurality of sub imaging devices 103 in the present embodiment may include two imaging devices 103a and 103b arranged so that the azimuth angles φ at which they image the surface 11a differ by 90 degrees to each other. For example, the sub imaging device 103a may be arranged so that the azimuth angle φ at which it images the surface 11a is a first azimuth angle φ1 (225 degrees) and the sub imaging device 103b may be arranged so that the azimuth angle φ at which it images the surface 11a is a second azimuth angle φ2 (315 degrees).

Here, the direction in which the surface 11a is imaged is a direction along an optical axis of the main imaging device 102 or of either of the sub imaging devices 103, and is a direction directed from the main imaging device 102 or either of the sub imaging devices 103 to the surface 11a. Also, the azimuth angle φ in the present embodiment is an angle on a plane parallel to the surface 11a (for example the XY-plane (the horizontal plane)), and is defined as an angle in a counterclockwise direction to a reference azimuth direction on the plane (for example, an X direction).

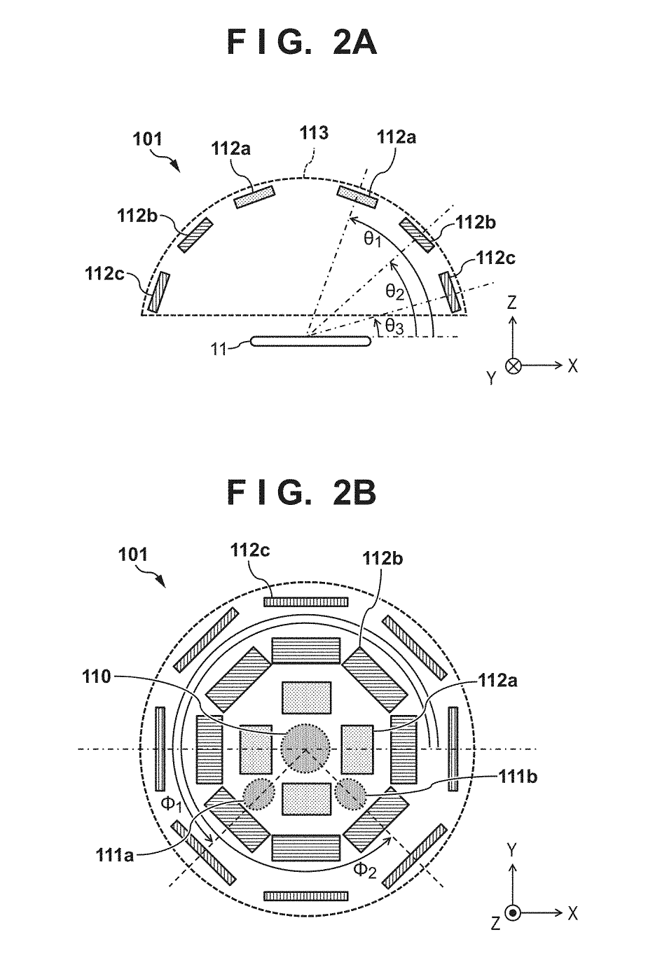

The illumination device 101 has a plurality of light sources 112 for irradiating a light from directions different from each other to the surface 11a so that the surface 11a can be illuminated from a plurality of directions. FIG. 2 is a view illustrating a configuration of the illumination device 101. FIG. 2A is a cross-sectional view of the illumination device 101 and FIG. 2B is a perspective view of the illumination device 101 as seen from above. The illumination device 101 of the present embodiment may include a cover member 113 (a support member) for surrounding the surface 11a (the work 11) and a plurality of the light sources 112 may be supported by the cover member 113 on the side of the cover member 113 facing the inspected surface. Here, the cover member 113 may be configured to have a light absorbent material with greater than or equal to 80% light absorptance on the side facing the inspected surface in order to reduce light that is reflected by the surface 11a being reflected by a surface of the cover member 113 the side facing the inspected surface and re-irradiated on the surface 11a. Also, directions in which light is irradiated to the surface 11a are the direction along optical axes of light emitted from the light sources 112 (112a, 112b, 112c) and are directions directed from the light sources 112 to the surface 11a.

A plurality of the light sources 112 may include for example a plurality (four) of the first light sources 112a, a plurality (eight) of the second light sources 112b, and a plurality (eight) of the third light sources 112c. The plurality of first light sources 112a are arranged so that an angle formed by the direction in which they irradiate light to the surface 11a and the surface 11a (hereinafter referred to as an irradiation angle lei) is a first angle θ1 and the azimuth angles φ at which they irradiate light to the surface 11a differ to each other. The plurality of second light sources 112b are arranged so that the irradiation angle θi is a second angle θ2 smaller than the first angle θ1 and the azimuth angles φ at which they irradiate light to the surface 11a differ to each other. The plurality of third light sources 112c are arranged so that the irradiation angle θi is a third angle θ3 smaller than the second angle θ2 and they irradiate light to the surface 11a from directions whose azimuth angles φ differ to each other. Here, it is advantageous that the first angle θ1 is in a range of 60±10 degrees, the second angle θ2 is in a range of 45±10 degrees, and the third angle θ3 is in a range of 30±10 degrees.

Also, an opening 110 for imaging the surface 11a by the main imaging device 102, and openings 111a and 111b for imaging the surface 11a by the sub imaging devices 103a and 103b respectively may be formed on the cover member 113. In the present embodiment, the imaging angle θc of the sub imaging devices 103a and 103b is configured to be the first angle θ1. Therefore, the openings 111a and 111b, illustrated in FIG. 2B, may be formed in the cover member 113 so that the azimuth angle φ is different from the azimuth angles φ at which each of the plurality of first light sources 112a is arranged, at a position of the first angle θ1 at which each of the plurality of first light sources 112a is arranged. However, limitation is not made to this configuration, and the sub imaging devices 103a and 103b may be arranged so that the imaging angle θc is equal to or less than the first angle and larger than the third angle (or the second angle), that is θ3<θc≦θ1 (or θ2<θc≦θ1) is satisfied. In such a case, the openings 111a and 111b may be formed in the cover member 113 so that they correspond to the arrangement of the sub imaging devices 103a and 103b.

[Regarding Appearance Inspection Method]

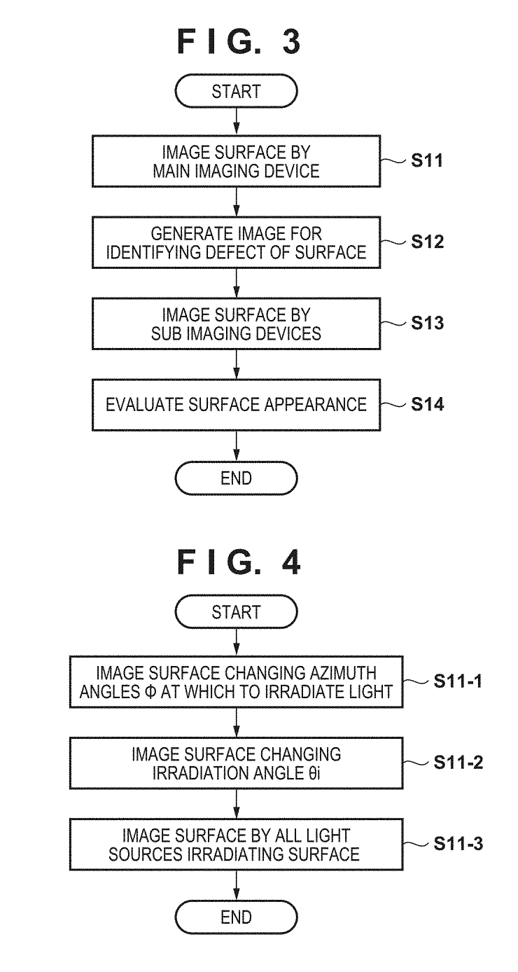

Next, explanation is given regarding a method for inspecting an appearance of the surface 11a using the inspection apparatus 10 described above with reference to FIG. 3. FIG. 3 is a flowchart illustrating a method of inspecting the appearance of the surface 11a. Each step of the flowchart illustrated in FIG. 3 may be controlled by the control unit 104, for example.

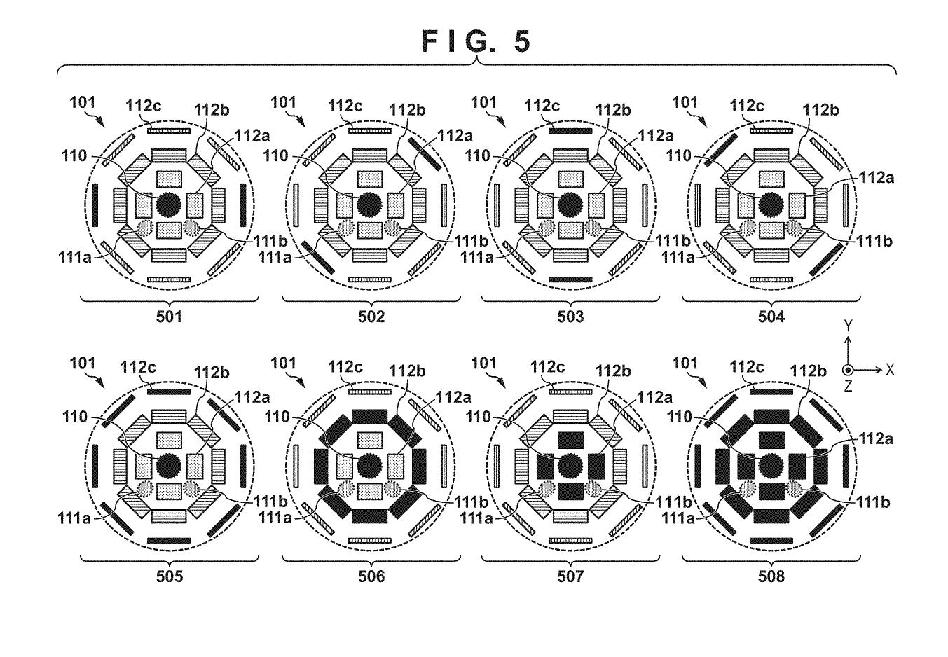

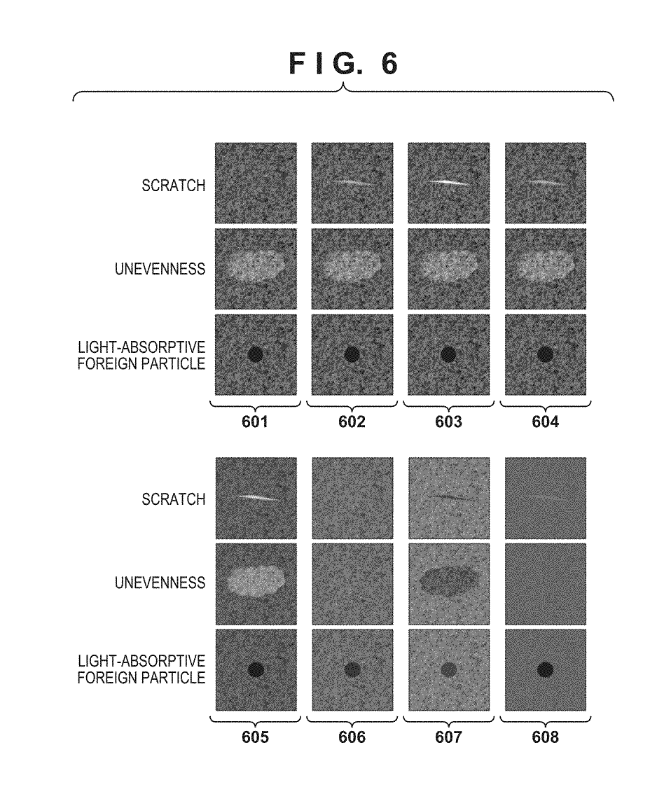

In step S11, the control unit 104 images the surface 11a a plurality of times by the main imaging device 102 while changing a direction in which the surface 11a is illuminated. Explanation is given below for the detail of step S11 with reference to FIG. 4 to FIG. 6. FIG. 4 is a flowchart for illustrating a method for imaging the surface 11a by the main imaging device 102 in step S11. FIG. 5 is perspective views of the illumination device 101 as seen from above, and corresponds to FIG. 2B. FIG. 5 is for describing states in which the light sources 112 that are illustrated by a blackening, among the plurality of light sources 112, are lit, that is, states in which light is irradiated onto the surface 11a. Also, FIG. 6 is views illustrating images which are defects of the surface 11a obtained by the main imaging device 102 in each of the states illustrated in FIG. 5. In FIG. 6, images of a scratch or an unevenness formed in the surface 11a, and a foreign particle having a property that it absorbs light (hereinafter referred to as a “light-absorptive foreign particle”) are respectively illustrated. Here, in step S11, a scratch of the surface 11a is compared to the scale of the surface roughness of the surface 11a and a scratch whose width is sufficiently wide or depth is sufficiently deep is made to be an inspection target. A scratch having a width and a depth that are approximately equal to the scale of the surface roughness of the surface 11a or less may be the inspection target in step S13 described later.

In step S11-1, the control unit 104 controls the illumination device 101 so that it enters a plurality of states in which the azimuth angles φ at which the light is irradiated to the surface 11a are different to each other, and controls the main imaging device 102 to image the surface 11a in each of this plurality of states. For example, the control unit 104 can make the azimuth angles φ at which the light is irradiated to the surface 11a differ from each other by changing the third light sources 112c that irradiate light to the surface 11a out of the plurality of third light sources 112c, as illustrated in 501 to 504 of FIG. 5. Then, images which are illustrated in reference numbers 601 to 604 of FIG. 6 can be obtained by the control unit 104 controlling the main imaging device 102 so as to image the surface 11a in each of the plurality of states in which the azimuth angles φ at which light is irradiated onto the surface 11a are mutually different. Here, in the images illustrated in reference numbers 601 to 604 of FIG. 6, brightness noise where the brightness differs in each pixel arises on part (hereinafter referred to as a normal portion) of the surface 11a in which a defect (a scratch, unevenness, or a light-absorptive foreign particle) is not formed. Such brightness noise can arise by light being scattered on the surface 11a due to the surface roughness of the surface 11a.

Reference numeral 501 of FIG. 5 illustrates a state in which the surface 11a is illuminated by using third light sources 112c which irradiate light onto the surface 11a from azimuth angles φ of 0 degrees and 180 degrees, and images which are illustrated in reference numeral 601 of FIG. 6 are obtained in this state. Reference numeral 502 of FIG. 5 illustrates a state in which the surface 11a is illuminated by using third light sources 112c which irradiate light onto the surface 11a from azimuth angles φ of 45 degrees and 225 degrees, and images which are illustrated in reference numeral 602 of FIG. 6 are obtained in this state. Reference numeral 503 of FIG. 5 illustrates a state in which the surface 11a is illuminated by using third light sources 112c which irradiate light onto the surface 11a from azimuth angles φ of 90 degrees and 270 degrees, and images which are illustrated in reference numeral 603 of FIG. 6 are obtained in this state. Reference numeral 504 of FIG. 5 illustrates a state in which the surface 11a is illuminated by using third light sources 112c which irradiate light onto the surface 11a from azimuth angles φ of 135 degrees and 315 degrees, and images which are illustrated in reference numeral 604 of FIG. 6 are obtained in this state. Although only the plurality of third light sources 112c are used in the step of step S11-1 of the present embodiment, limitation is not made to this, and the plurality of first light sources 112a or the plurality of second light sources 112b may be used for example.

For a scratch of the surface 11a, the appearance on the image changes in accordance with the azimuth angles φ when the azimuth angles φ at which light is irradiated onto the surface 11a are altered, as illustrated in reference numerals 601 to 604 of FIG. 6. For example, when light is irradiated onto the surface 11a at azimuth angles φ parallel to the azimuth angle in which a scratch extends as illustrated in reference numeral 601 of FIG. 6, detecting the scratch on the image is difficult. Meanwhile, when light is irradiated onto the surface 11a at azimuth angles φ that are different (for example, orthogonal) to the azimuth angle in which a scratch extends as illustrated in reference numeral 603 of FIG. 6, it is possible to easily detect the scratch on the image. This is because more light is reflected or scattered by the scratch and incident on the main imaging device 102 the closer the angle difference between an azimuth angle φ at which the light is irradiated onto the surface 11a and the azimuth angle in which the scratch extends is to 90 degrees. In this way, it is possible to obtain an image for inspecting a scratch of the surface 11a by causing the azimuth angles φ at which the light is irradiated onto the surface 11a to change. Here regarding a light-absorptive foreign particle or an unevenness of the surface 11a, the appearance on the image as illustrated in reference numerals 601 to 604 of FIG. 6 is mostly unchanged even if the azimuth angles φ at which the light is irradiated onto the surface 11a is altered. For this reason, an image for inspecting an unevenness in step S11-2 and an image for inspecting a light-absorptive foreign particle in step S11-3 may be obtained respectively.

In step S11-2, the control unit 104 controls the illumination device 101 such that it enters a plurality of states in which the irradiation angles θi are different to each other and controls the main imaging device 102 such that the surface 11a is imaged in each of the plurality of states. For example, the control unit 104 can control the illumination device 101 so as to irradiate light onto the surface 11a by the plurality of third light sources 112c as illustrated in reference numeral 505 of FIG. 5, and obtain images illustrated in reference numeral 605 of FIG. 6 when it causes the main imaging device 102 to image the surface 11a in this state. Also, the control unit 104 can control the illumination device 101 so as to irradiate light onto the surface 11a by the plurality of second light sources 112b as illustrated in reference numeral 506 of FIG. 5, and obtain images illustrated in reference numeral 606 of FIG. 6 when it causes the main imaging device 102 to image the surface 11a in this state. Similarly, the control unit 104 can control the illumination device 101 so as to irradiate light onto the surface 11a by the plurality of first light sources 112a as illustrated in reference numeral 507 of FIG. 5, and obtain images illustrated in reference numeral 607 of FIG. 6 when it causes the main imaging device 102 to image the surface 11a in this state.

Here, when the irradiation angle θi is changed, an intensity of light that is reflected by the surface 11a and is incident on the main imaging device 102 may change due to surface roughness of the surface 11a. For this reason, it is desirable to adjust the intensity of the light emitted from each light source 112 such that the intensities of the light incident on the main imaging device 102 becomes the same in the plurality of states in a case in which the surface 11a is imaged in each of the plurality of states whose irradiation angles θi are different from each other.

For a scratch of the surface 11a, the appearance on the image changes in accordance with the irradiation angle θi when the irradiation angle θi is altered as illustrated in reference numerals 605 to 607 of FIG. 6. For example, the brightness of a scratch becomes greater than the normal portion in an image (reference numeral 605 of FIG. 6) when the plurality of third light sources 112c are used. Also, the brightness of a scratch becomes the same as the normal portion in an image (reference numeral 606 of FIG. 6) when the plurality of second light sources 112b are used and the brightness of a scratch becomes less than the normal portion in an image (reference numeral 607 of FIG. 6) when the plurality of first light sources 112a are used. This is because the intensity of the light reflected by a side surface of the scratch (a surface which configures the scratch) and incident on the main imaging device 102 changes in accordance with the irradiation angle θi.

For an unevenness of the surface 11a, the appearance on the image changes in accordance with the irradiation angle θi when the irradiation angle θi is altered as illustrated in reference numerals 605 to 607 of FIG. 6. This is because, similarly to the scratch, the intensity of the light reflected by the unevenness and incident on the main imaging device 102 changes in accordance with the irradiation angle θi. Meanwhile, regarding a light-absorptive foreign particle, the appearance on the image is mostly unchanged even if the irradiation angle θi is altered. Here, the brightness noise in the normal portion is smaller in the images illustrated in reference numerals 605 to 607 of FIG. 6 compared to the reference numerals 601 to 604 of FIG. 6. This is because the brightness of each pixel is averaged by irradiating the light on the surface 11a using the plurality of light sources 112 arranged at mutually different azimuth angles cp.

In step S11-3, the control unit 104 controls the illumination device 101 so as to irradiate light onto the surface 11a using all of the light sources 112c as illustrated in reference numeral 508 of FIG. 5, and controls the main imaging device 102 to image the surface 11a in that state. By this, the control unit 104 can obtain the image illustrated in reference numeral 608 of FIG. 6. In such a case, for the scratch and the unevenness of the surface 11a, the brightness becomes the same as the normal portion and detection is difficult. Meanwhile, it becomes possible to easily detect a light-absorptive foreign particle of the surface 11a because a difference of the brightness with respect to the normal portion becomes greater. Here, the brightness noise in the normal portion is smaller in the image illustrated in reference numerals 608 of FIG. 6 compared to the reference numerals 605 to 607 of FIG. 6. This is because the brightness between each pixel is additionally averaged by illuminating the surface 11a by using all light sources 112.

Returning to the flowchart of FIG. 3, the control unit 104 in step S12 generates an image for detecting a defect (a scratch, unevenness, a light-absorptive foreign particle) of the surface 11a based on the images obtained in step S11. For example, after the control unit 104 performs shading correction on each of the four images (reference numerals 601 to 604 of FIG. 6) obtained in the step of step S11-1, it obtains differences between maximum values and minimum values of the brightness in the four images after correction for each position of the pixels. Regarding a scratch having a width and a depth larger than the scale of the surface roughness of the surface 11a, the brightness of the scratch in the image changes greatly compared to the normal portion when the azimuth angles φ at which light is irradiated onto the surface 11a are altered as illustrated in the four images of reference numerals 601 to 604 of FIG. 6. For this reason, it is possible for the control unit 104 to obtain a combined image in which a scratch can be easily detected by obtaining differences between maximum values and minimum values of the brightness in the four images as illustrated in reference numeral 701 of FIG. 7.

Also, after the control unit performs shading correction on each of the three images (reference numerals 605 to 607 of FIG. 6) obtained in the step of step S11-2, it obtains a difference between the maximum value and the minimum value of the brightness in the three images after correction for each position of the pixels. Regarding a scratch and an unevenness of the surface 11a, the brightness of the scratch and the unevenness in the image changes greatly compared to the normal portion as illustrated in the three images of reference numerals 605 to 607 of FIG. 6 when the irradiation angle θi is altered. For this reason, it is possible for the control unit 104 to obtain a combined image in which a scratch and an unevenness can be easily detected by obtaining differences between maximum values and minimum values of the brightness in the three images as illustrated in reference numeral 702 of FIG. 7. Note that regarding a light-absorptive foreign particle, it can be easily detected according to the image (reference numeral 608 of FIG. 6) obtained in the step of step S11-3 even if a combined image is not generated. Also, an image of a non-defective product without a defect may also be added when a combined image is generated.

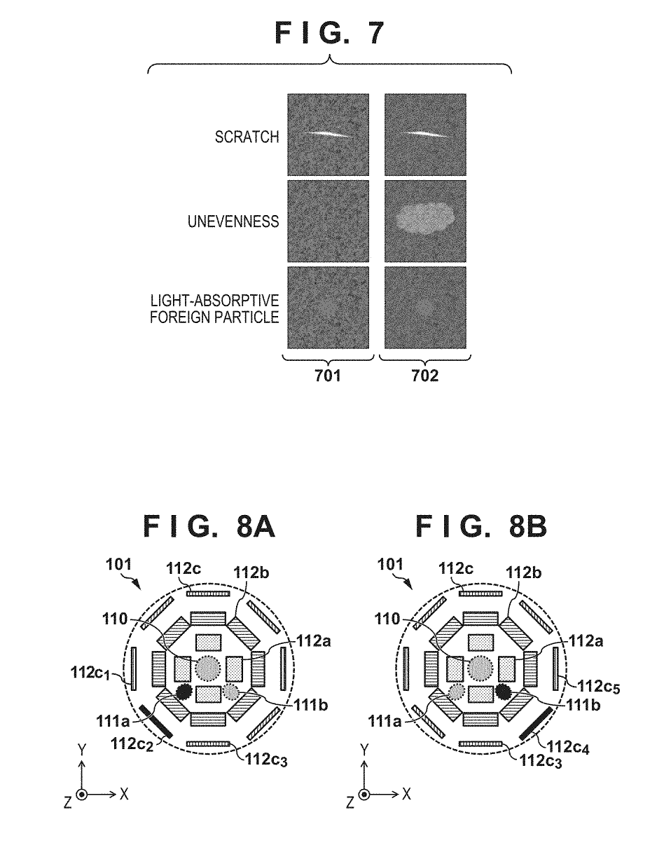

Here, a detection of a scratch (hereinafter referred to as a micro scratch) having a width and a depth the same as or less than a scale of the surface roughness of the surface 11a will be described. In the steps of step S11 and step S12, it is difficult to generate an image in which a micro scratch can be detected. For this reason, in step S13 the control unit 104 of the present embodiment obtains images for detecting a micro scratch formed on the surface 11a by imaging the surface 11a by each of the sub imaging devices 103a and 103b. Explanation is given below for the detail of step S13 with reference to FIG. 8 to FIG. 11.

FIG. 8A and FIG. 8B are perspective views of the illumination device 101 as seen from above, and corresponds to FIG. 2B. FIG. 8A and FIG. 8B describe states in which the light source 112 that is illustrated by a blackening, among the plurality of light sources 112, are lit, that is, states in which light is irradiated onto the surface 11a. Also, FIG. 8A is a view illustrating control of the illumination device 101 in a case in which the surface 11a is imaged by the sub imaging device 103a, and FIG. 8B is a view illustrating control of the illumination device 101 in a case in which the surface 11a is imaged by the sub imaging device 103b.

The control unit 104 controls the illumination device 101 such that the surface 11a is illuminated by a light source 112 for which the angle difference between the azimuth angle φ at which the surface 11a is imaged and the azimuth angle φ at which the light is irradiated onto the surface 11a is less than 90 degrees in a case in which the surface 11a is imaged by the sub imaging device 103a. At that time, the control unit 104 may control the illumination device 101 such that the irradiation angle θi is smaller than the imaging angle θc of the sub imaging device 103a. For example, the control unit 104 may control the illumination device 101 such that the surface 11a is illuminated by at least one among the three third light sources 112c1, 112c2, and 112c3 which satisfy the above described conditions in a case in which the surface 11a is imaged by the sub imaging device 103a. In the present embodiment, the control unit 104 controls the illumination device 101 such that the surface 11a is illuminated by the third light source 112c2 as illustrated in FIG. 8A in a case in which the surface 11a is imaged by the sub imaging device 103a.

The control unit 104 controls the illumination device 101 such that the surface 11a is illuminated by a light source 112 for which the angle difference between the azimuth angle φ at which the surface 11a is imaged and the azimuth angle φ at which the light is irradiated onto the surface 11a is less than 90 degrees in a case in which the surface 11a is imaged by the sub imaging device 103b. At that time, the control unit 104 may control the illumination device 101 such that the irradiation angle θi is smaller than the imaging angle θc of the sub imaging device 103b. For example, the control unit 104 may control the illumination device 101 such that the surface 11a is illuminated by at least one among the third light sources 112c3, 112c4, and 112c5 which satisfy the above described conditions in a case in which the surface 11a is imaged by the sub imaging device 103b. In the present embodiment, the control unit 104 controls the illumination device 101 such that the surface 11a is illuminated by the third light source 112c4 as illustrated in FIG. 8B in a case in which the surface 11a is imaged by the sub imaging device 103b.

Next, description will be given regarding the reason that it is possible to detect a micro scratch on an image obtained by each of the sub imaging devices 103a and 103b by controlling the illumination device 101 as described above. FIG. 9 is a view illustrating an intensity distribution of scattered light in a normal portion of the surface 11a. Scattered light is generated in the normal portion of the surface 11a in a case in which the surface 11a that is the inspection target is a rough surface. The scattered light, as illustrated in FIG. 9, forms a distribution wherein light intensity is strongest in a direction of a specular reflection of the illumination light, and light intensity becomes weaker the more separated the direction is from that of specular reflection. For this reason, it is possible to decrease the intensity of the scattered light incident on the sub imaging devices 103 when the illumination device 101 is controlled as described above in the case in which the surface 11a is imaged by the sub imaging devices 103. Specifically, an S/N ratio can be increased in an image obtained by the sub imaging devices 103.

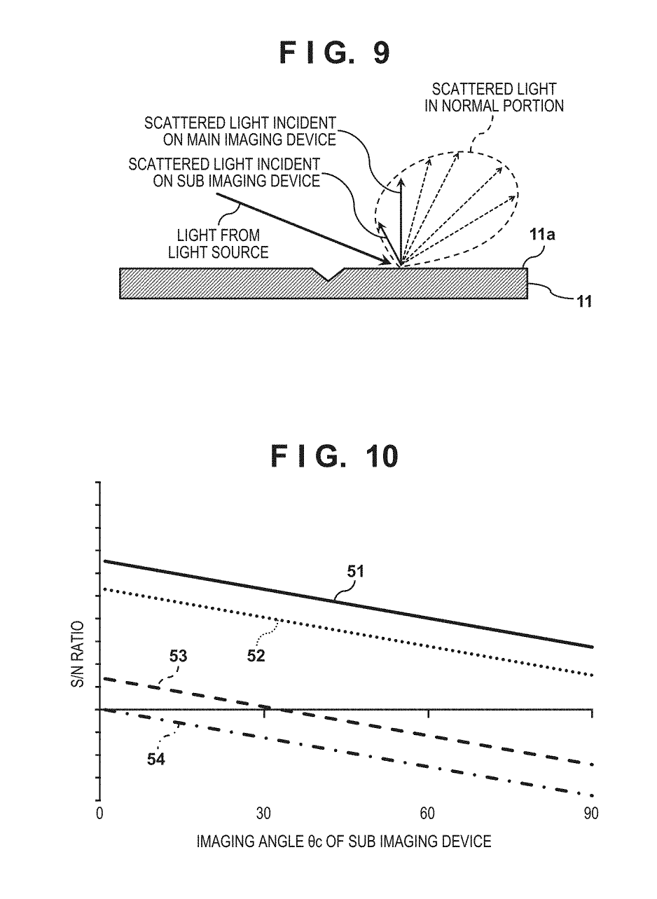

FIG. 10 is a view illustrating a relationship between an imaging angle θc of the sub imaging device 103 and an S/N ratio for a micro scratch. An abscissa in FIG. 10 indicates the imaging angle θc of the sub imaging device 103 and an ordinate indicates an S/N ratio. A line 51 and a line 52 in the figure indicate a relationship between the imaging angle θc and the S/N ratio in a case in which the azimuth angle φ at which the surface 11a is imaged and the azimuth angle φ at which the light is irradiated on the surface 11a are the same. A line 53 and a line 54 in the figure indicate a relationship between the imaging angle θc and the S/N ratio in a case in which the azimuth angle φ at which the surface 11a is imaged and the azimuth angle φ at which the light is irradiated on the surface 11a differ by 180 degrees. Also, the line 51 and the line 54 indicate a case in which the third light sources 112c are used, and the line 52 and the line 53 indicate a case in which the second light sources 112b are used.

With reference to FIG. 10, the S/N ratio is higher in a case in which the azimuth angle φ at which the light is irradiated onto the surface 11a and the azimuth angle φ at which the surface 11a is imaged are the same than in a case in which the azimuth angle φ of these differ by 180 degrees. This indicates that the S/N ratio becomes higher for a smaller angle difference between the azimuth angle φ at which the light is irradiated onto the surface 11a and the azimuth angle φ at which the surface 11a is imaged. Also, the S/N ratio is higher when the surface 11a is illuminated by the third light sources 112c than when the surface 11a is illuminated by the second light sources 112b. This indicates that the S/N ratio becomes higher when the irradiation angle θi is smaller. Specifically, it can be seen that in order to easily detect a micro scratch on the top of the image obtained by the sub imaging devices 103, the surface 11a may be illuminated such that the angle difference between the azimuth angle φ at which the light is irradiated on the surface 11a and the azimuth angle φ at which the surface 11a is imaged and the irradiation angle θi become smaller together.

Also, with reference to FIG. 10, the S/N ratio becomes larger as the imaging angle θc becomes smaller. From this, it can be seen that it is possible to more easily detect a micro scratch on an image by making the S/N ratio higher in an image when imaging the surface 11a by the sub imaging devices 103 whose imaging angle θc is smaller than the main imaging device 102. However, the smaller the imaging angle θc is, the more the imaging of the surface 11a is from a diagonal, and therefore the need arises to make a depth of focus larger in order to image the surface 11a collectively. For this reason, it is advantageous for the imaging angle θc of the sub imaging devices 103 to be set within a range of 60±10 degrees considering the depth of focus.

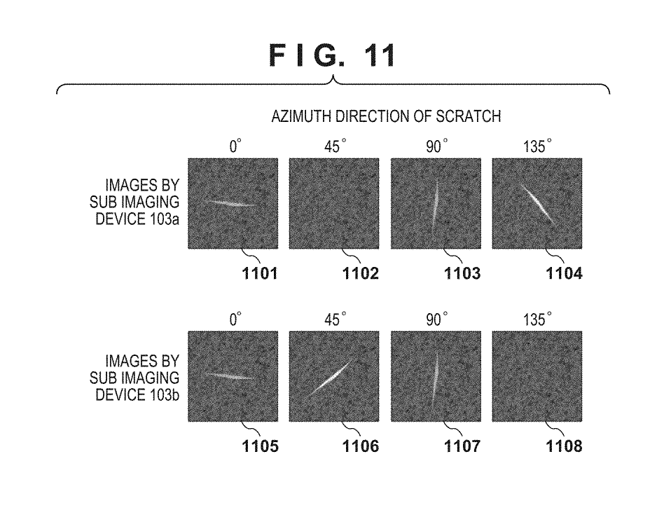

FIG. 11 is views illustrating images obtained by imaging a micro scratch by each the sub imaging devices 103a and 103b. Reference numerals 1101 to 1104 of FIG. 11 indicate images obtained by the sub imaging device 103a, and reference numerals 1105 to 1108 of FIG. 11 indicate images obtained by the sub imaging device 103b. Also, the reference numerals 1101 and 1105 of FIG. 11 indicate images when the azimuth angle in which the micro scratch extends is 0 degrees, and the reference numerals 1102 and 1106 of FIG. 11 indicate images when the azimuth angle in which the micro scratch extends is 45 degrees. The reference numerals 1103 and 1107 of FIG. 11 indicate images when the azimuth angle in which the micro scratch extends in is 90 degrees, and the reference numerals 1104 and 1108 of FIG. 11 indicate images when the azimuth angle in which the micro scratch extends in is 135 degrees.

The S/N ratio becomes highest when the azimuth angle in which a micro scratch extends is 135 degrees (reference 1104 of FIG. 11) in the images (reference numeral 1101 to 1104 of FIG. 11) obtained by the sub imaging device 103a. This is because as the azimuth direction in which the micro scratch extends gets closer to being orthogonal with respect to the azimuth direction at which the surface 11a is imaged by the sub imaging device 103a, the intensity of the light reflected by the micro scratch and incident on the sub imaging device 103a becomes higher. For this reason, when the azimuth angle in which the micro scratch extends is 45 degrees (reference numeral 1102 of FIG. 11), the azimuth direction in which the micro scratch extends is parallel to the azimuth direction at which the surface 11a is imaged by the sub imaging device 103a, and the S/N ratio is lowest.

Also, in the images (reference numeral 1105 to 1108 of FIG. 11) obtained by the sub imaging device 103b, the S/N ratio is highest when the azimuth angle in which a micro scratch extends is 45 degrees (reference numeral 1106 of FIG. 11) and the S/N ratio is lowest when the azimuth angle in which a micro scratch extends is 135 degrees (reference numeral 1108 of FIG. 11). Specifically, it is advantageous that the two sub imaging devices 103a and 103b are arranged such that the azimuth angles at which they image the surface 11a differ by 90 degrees to each other for more precise detection of a micro scratch of the surface 11a. In this way, by arranging the two sub imaging devices 103a and 103b, even if in a case in which a micro scratch cannot be detected by one of the sub imaging devices 103 the micro scratch can be detected by the other sub imaging device 103.

In the present embodiment, although description is given regarding an example in which two sub imaging devices 103 are used, three or more sub imaging devices 103 may be used. Also, in the present embodiment, although description is given regarding an example in which in a case in which the surface 11a is imaged by the sub imaging devices 103, the surface 11a is illuminated such that the azimuth angle φ at which the surface 11a is imaged and the azimuth angle φ at which the light is irradiated onto the surface 11a become the same, limitation is not made to this. For example, if the angle difference between the azimuth angle φ at which the surface 11a is imaged and the azimuth angle φ at which the light is irradiated onto the surface 11a is less than 90 degrees, these the azimuth angles φ may different from each other.

Returning to the flowchart of FIG. 3, in step S14 the control unit 104 evaluates the appearance of the surface 11a (work 11) based on the images obtained by the main imaging device 102 and the images obtained by the sub imaging devices 103. For example, the control unit 104 can perform an evaluation of whether or not a scratch (also including a micro scratch) is on the surface 11a based on the combined images (reference numerals 701 and 702 of FIG. 7) generated in the step of step S12 and the images (reference numerals 1101 to 1108 of FIG. 11, for example) obtained in step S13. Also, the control unit 104 can perform an evaluation of whether or not there is an unevenness on the surface 11a based on a combined image (reference numeral 702 of FIG. 7) generated in the step of step S12, and can perform an evaluation of whether or not there is a light-absorptive foreign particle on the surface 11a based on the image (reference numeral 608 of FIG. 6) obtained in the step of step S11-3. Here, the image that can be used in order to evaluate the appearance of the surface 11a is not limited to what is described above, and the control unit 104 may evaluate the appearance of the surface 11a further based on a combined image or any of the images illustrated in FIG. 6, FIG. 7, and FIG. 11, for example. Also, in the present embodiment, the image which is illustrated in reference numeral 608 of FIG. 6 is obtained by using all of the light sources 112 to illuminate the surface 11a and an evaluation of whether or not a light-absorptive foreign particle is on the surface 11a based on the image is performed. However, limitation is not made to this, and an image obtained by combining or averaging the images illustrated in reference numerals 605 to 607 of FIG. 6 may be used in place of the image illustrated in reference numeral 608 of FIG. 6, for example.

Hereinafter, description will be given for one example of a method for evaluating the appearance of the surface 11a by the control unit 104. In the present embodiment, firstly, the control unit 104 learns images of a plurality of non-defective products and generates a quality determination model for calculating a score used for determining the quality of the appearance. Specifically, the control unit 104 generates a quality determination model by, based on the images of the plurality of non-defective products, determining a valid plurality of image features in the quality determination of the appearance, and automatically determining a method for calculating a degree of abnormality (or a degree of normality) score from a feature amount of each image feature.

Next, the control unit 104, from images obtained by imaging a work 11 (surface 11a) of an inspection target, calculates a degree of abnormality score by obtaining the feature amount of the work 11 regarding each image feature, and determines the quality of the appearance of the surface 11a based on the calculated degree of abnormality score. Specifically, the control unit 104 references a degree of abnormality score threshold that a user set in advance, and determines the work 11 to be a defective product if the degree of abnormality score for the work 11 which is the inspection target is greater than or equal to the threshold, and determines the work 11 to be a non-defective product if it is smaller than the threshold. Here, the plurality of image features can include a scratch, unevenness, or a light-absorptive foreign particle on the work 11 (surface 11a) for example. Also, although a plurality of quality determination models may be generated such that a score is calculated for each of a plurality of image features, it is advantageous that one quality determination model be generated so that one score is calculated from the plurality of image features in the interests of shortening the evaluation time.

As described above, the inspection apparatus 10 of the present embodiment evaluates the appearance of the surface 11a based on a plurality of images obtained by imaging the surface 11a by the main imaging device 102 and the plurality of the sub imaging devices 103. Because of this, it is possible to detect a defect of the surface 11a with more precision. In particular, the inspection apparatus 10 of the present embodiment, in a case in which the surface 11a is imaged by the sub imaging devices 103, controls the illumination device 101 so that the angle difference between the azimuth angle φ at which the surface 11a is imaged and the azimuth angle φ at which the light is irradiated onto the surface 11a becomes smaller than 90 degrees. By this, it is possible to detect a micro scratch formed on the surface 11a with more precision.

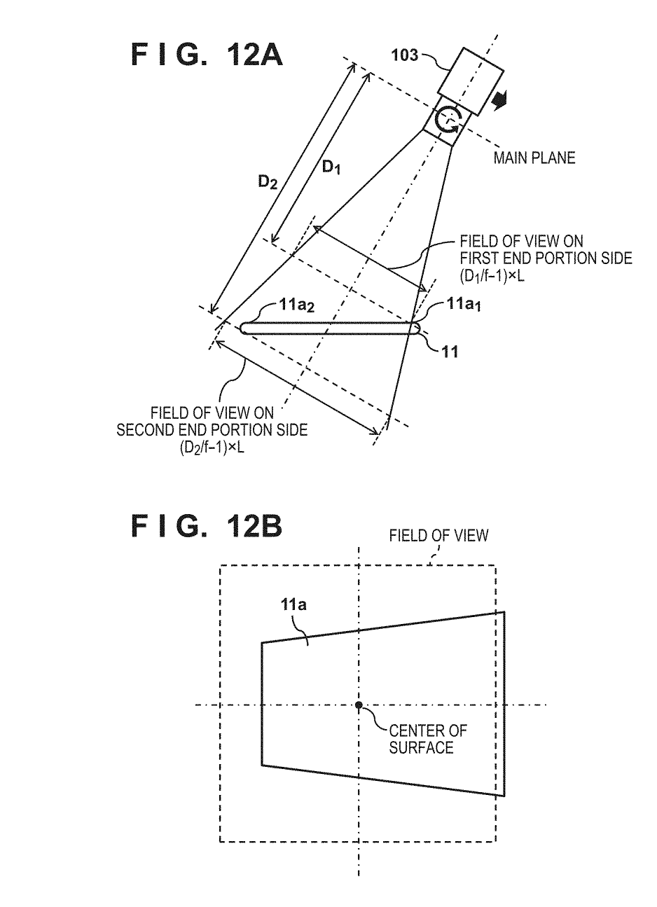

Here, description is given regarding an arrangement of the sub imaging devices 103 while referencing FIG. 12A and FIG. 12B. FIG. 12A is a view illustrating a position relation between the sub imaging devices 103 and the work 11 (surface 11a) and FIG. 12B is a view illustrating a field of view (an image obtained by the sub imaging devices 103) of the sub imaging devices 103. The sub imaging devices 103 are arranged to be tilted with respect to the surface 11a because the surface 11a is imaged from a direction for which the imaging angle θc is less than 90 degrees as illustrated in FIG. 12A. For this reason, a distance from the main plane of the lens of the sub imaging device 103 to the surface 11a is D₁ at an end portion 11a₁ of the surface 11a closer to the sub imaging device 103 and is D₂ at an end portion 11a₂ of the surface 11a further from the sub imaging devices 103, and a difference in accordance with the position on the surface can arise. In other words, the appearance of the surface 11a in the sub imaging device 103 may differ between the end portion 11a₁ side and the end portion 11a₂ side if the lens in the sub imaging device 103 is non-telecentric.

Specifically, the field of view of the sub imaging device 103 is expressed by (D/f−1)×L when the focal length of the lens of the sub imaging device 103 is f, the size (length of one side) of the image sensor of the sub imaging device 103 is L, and the distance between the sub imaging device 103 and the surface 11a is D. That is, the field of view of the sub imaging device 103 at the end portion 11aᵢ side (distance D₁) is (D₁/f−1)×L and the field of view of the sub imaging device 103 at the end portion 11a₂ side (distance D₂) is (D₂/f−1)×L, and the appearance of the surface 11a differs between the end portion 11aᵢ and the end portion 11a₂.

Accordingly, in the sub imaging device 103, an image is obtained wherein the size of the surface 11a on the image gets larger as the distance between the surface 11a and the sub imaging devices 103 becomes closer. At that time, the entirety of the surface 11a may not fit within the image as is illustrated in FIG. 12B when the sub imaging device 103 is arranged such that the center of the field of view of the sub imaging device 103 and the center of the surface 11a are aligned. For that reason, in the sub imaging devices 103, it is advantageous that the center of the field of view be shifted from the center of the surface 11a such that the entirety of the surface 11a fits within the image.

Also, in the main imaging device 102, the aperture of the lens may be set to a state in which it is widened to a certain degree such that the imaging time is shortened in order to image the surface 11a multiple times while changing the light sources 112 used for irradiating light onto the surface 11a. It is possible to detect with more precision a defect of the surface 11a because the resolution improves when imaging the surface 11a in a state in which the aperture of the lens is widened. Meanwhile, in the sub imaging devices 103, the aperture of the lens may set to a state in which it is closed to a certain degree because it is advantageous to image the surface 11a collectively so as to decrease being out-of-focus. Accordingly, the aperture of the lens of the main imaging device 102 may be set to be more open than the apertures of the lenses of the sub imaging devices 103.

In such a case, the amount of light incident on the image sensors of the sub imaging devices 103 is smaller than the amount of light incident on the image sensor of the main imaging device 102. For this reason, in the images obtained by the sub imaging devices 103, noise may be greater than in the image obtained by the main imaging device 102. Accordingly, it is advantageous in cases when the surface 11a is imaged by the sub imaging devices 103, compared to a case in which the surface 11a is imaged by the main imaging device 102, that imaging time is lengthened and the intensity of the light irradiated onto the surface 11a by the illumination device 101 is made larger.

In the present embodiment, although description is given of an example using, as the lens of the sub imaging device 103, a lens configured such that the object plane and the imaging plane are parallel, limitation is not made to this. For example, a lens configured such that it satisfies a shine-proof condition may be used as the lens of the sub imaging devices 103. In such a case, because it is not necessary that the aperture of the lens of the sub imaging devices 103 be closed to a certain degree, compared to a case in which the surface 11a is imaged by the main imaging device 102, imaging time need not be lengthened and the intensity of the light irradiated onto the surface 11a by the illumination device 101 need not be increased.

Also, in the present embodiment, although an example is described in which only one image is obtained (image) by each of the sub imaging devices 103a and 103b, limitation is not made to this. In addition to this, separate images may be further obtained (imaged) by illuminating the surface 11a by a light source for which the azimuth direction is different than this. For example, a defect in which there is a moderate tilt of the surface can be visualized at a high contrast by illuminating the surface 11a by a light sources in azimuth directions opposite to those of the cameras, and imaging by the sub imaging devices 103. In this way, not only defects such as a micro scratch but various other defects can be detected by obtaining a plurality of images of differing illumination conditions by the sub imaging devices 103.

[Embodiments according to a Method of Manufacturing an Article]

The inspection apparatus according to the embodiments described above can be used in a method of manufacturing an article. The method of manufacturing an article can include a step for performing an inspection of an object by using the inspection apparatus and a step for processing an object on which the inspection is performed in that step. The processing can include at least one among measurement, processing, cutting, conveyance, setup (assembly), inspection, and selection for example. The method of manufacturing an article of the present embodiment is advantageous compared to conventional methods in at least one among product capabilities, quality, productivity, and manufacturing cost.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-257327 filed on Dec. 28, 2015, which is hereby incorporated by reference herein in its entirety.

What is claimed is:

1. An inspection apparatus that performs an inspection of an appearance of a surface, the apparatus comprising:
a plurality of imaging devices each of which is configured to image the surface obliquely from above the surface;
an illumination device including a plurality of light sources and configured to illuminate the surface from mutually different directions; and
a processor configured to cause each of the plurality of imaging devices to image the surface, and perform processing of the inspection based on a plurality of images obtained by the plurality of imaging devices,
wherein the plurality of imaging devices are arranged such that azimuth directions, in which the plurality of imaging devices respectively images the surface, are mutually different, and
wherein the processor is configured to control, in a case where each of the plurality of imaging devices is caused to image the surface, the illumination device such that the surface is illuminated by a light source, of the plurality of light sources, of which an angle difference between an azimuth angle in which the surface is imaged and an azimuth angle in which the surface is illuminated is less than 90 degrees.

2. The apparatus according to claim 1, wherein the light source to be used in the case where each of the plurality of imaging devices is caused to image the surface is a light source that satisfies a condition that an angle formed between the surface and a direction in which the surface is illuminated smaller than an angle formed between the surface and a direction in which the surface is imaged.

3. The apparatus according to claim 1, further comprising a support configured to support the plurality of light sources,
wherein a face of the support facing the surface has a light absorptivity not less than 80%.

4. The apparatus according to claim 1, wherein the plurality of imaging devices include two imaging devices arranged such that azimuth angles at which the two imaging devices respectively image the surface are different from each other by 90 degrees.

5. The apparatus according to claim 1, wherein the plurality of light sources include a plurality of first light sources each of which has a first angle between the surface and a direction in which the surface is illuminated thereby, and a plurality of second light sources each of which has a second angle, smaller than the first angle, between the surface and a direction in which the surface is illuminated thereby, and
each of the plurality of imaging devices is arranged such that an angle formed between the surface and a direction in which the surface is imaged thereby is less than the first angle and greater than the second angle.

6. The apparatus according to claim 5, wherein the plurality of light sources includes a plurality of third light sources each of which has a third angle, smaller than the second angle, between the surface and a direction in which the surface is illuminated thereby.

7. The apparatus according to claim 1, wherein light sources to be respectively used in cases where the plurality of imaging devices image the surface are mutually different.

8. The apparatus according to claim 1, wherein a light source to be used in a case where the surface is imaged by each of the plurality of imaging devices has an angle within a range of 30±10 degrees between the surface and a direction in which the surface is illuminated thereby.

9. The apparatus according to claim 1, wherein each of the plurality of imaging devices is arranged such that an angle formed between the surface and a direction in which the surface is imaged thereby is within a range of 60±10 degrees.

10. The apparatus according to claim 1, wherein each of the plurality of imaging devices includes an image sensor.

11. The apparatus according to claim 1, further comprising a second imaging device configured to image the surface from above, wherein
the processor is configured to perform the processing further based on an image obtained by the second imaging device.

12. An inspection apparatus that performs an inspection of an appearance of a surface, the apparatus comprising:
an illumination device configured to illuminate the surface obliquely from above the surface;
an imaging device configured to image the surface obliquely from above the surface;
a processor configured to perform processing of the inspection based on an image obtained by causing the imaging device to image the surface illuminated by the illumination device,
wherein the apparatus is configured such that the illumination device illuminates the surface in an azimuth direction in which the imaging device images the surface.

13. An inspection system that performs an inspection of an appearance of a surface of an object, the system comprising:
the inspection apparatus according to claim 12; and
a conveyer configured to convey the object to a position at which the inspection apparatus performs an inspection.

14. A method for manufacturing an article, the method comprising steps of:
performing an inspection of an appearance of a surface of an object using an inspection apparatus; and
processing the object, of which the inspection is performed, to manufacture the article,
wherein the inspection apparatus includes:
an illumination device configured to illuminate the surface obliquely from above the surface;
an imaging device configured to image the surface obliquely from above the surface;
a processor configured to perform processing of the inspection based on an image obtained by causing the imaging device to image the surface illuminated by the illumination device,
wherein the apparatus is configured such that the illumination device illuminates the surface in an azimuth direction in which the imaging device images the surface.
